(19) United States
(12) Patent Application Publication
(10) Pub. No.: US 2026/0134623 A1
(43) Pub. Date: May 14, 2026

(54) PRIOR MODEL FOR GAUSSIAN SPLATTING - BASED AVATARS

(71) Applicant: Microsoft Technology Licensing, LLC, Redmond, WA (US)

(72) Inventors: Charles Thomas Hewitt, Cambridge (GB); Benjamin Eliot Lundell, Seattle, WA (US); Jack Roe Saunders, Bath (GB); Yanan Jian, Palo Alto, CA (US)

(21) Appl. No.: 19/212,000

(22) Filed: May 19, 2025

Related U.S. Application Data
(60) Provisional application No. 63/719,998, filed on Nov. 13, 2024.
(60) Provisional application No. 63/724,788, filed on Nov. 25, 2024.

(51) Int. Cl. G06T 17/10; G06N 3/04; G06N 3/08; G06T 3/4038; G06T 19/20

(52) U.S. Cl. CPC G06T 17/10; G06N 3/04; G06N 3/08; G06T 3/4038; G06T 19/20; G06T 2219/2004; G06T 2219/2012; G06T 2219/2016

(57) ABSTRACT

A system and method for rendering three-dimensional digital representations of users are disclosed. The described approach addresses challenges in generating photorealistic avatars with minimal input data by utilizing a deep neural network (DNN)-based prior model. The prior model is trained to identify features and generate a canonical template representing average user characteristics. During an enrollment phase, personalized offsets are determined for individual users based on their distinguishing features. These offsets, combined with the canonical template, enable the generation of high-quality, real-time 3D avatars from a single audio or visual input. The avatars can be animated based on user signals, such as expressions or sounds, captured by input devices. Applications include virtual reality, gaming, video conferencing, and entertainment. The system reduces computational resource requirements while improving rendering speed and fidelity, enabling efficient avatar generation and animation in communication sessions.

### PRIORITY CLAIM

This application claims priority to U.S. Provisional Patent Application No. 63/719,998, filed Nov. 13, 2024, and titled “PRIOR FOR GAUSSIAN SPLATTING-BASED AVATARS” and claims priority to U.S. Provisional Application 63/724,788, filed Nov. 25, 2024, and titled “GASP: GAUSSIAN AVATARS WITH SYNTHETIC PRIORS,” the entire disclosures of which are incorporated herein by reference in their entireties.

### TECHNICAL FIELD

Examples pertain to rendering three-dimensional digital representations. Some examples pertain to rendering three-dimensional digital representations using first and second templates.

### BACKGROUND

Rendering high-quality digital representations of humans for use in various applications, such as virtual/mixed reality, gaming, video conferencing, and entertainment can enhance a user experience. High-quality digital representations should be photorealistic and capable of real-time rendering. Neural Radiance Fields (NeRFs) deep learning techniques have been used to construct three-dimensional renderings from two-dimensional images. In addition, Gaussian splatting has been used to render high-quality digital representations. Gaussian splatting is a volume rendering technique that creates three-dimensional images using tiny, translucent ellipsoids that are referred to as Gaussian splats.

### BRIEF DESCRIPTION OF THE DRAWING

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows an environment in which examples may operate, according to some examples of the present disclosure.

FIGS. 2 and 3 show mesh-based representations that can be used to generate digital representations, according to some examples of the present disclosure.

FIG. 4 is an architecture that may be implemented by a server device of FIG. 1 to generate a canonical Gaussian template and personalized Gaussian offsets that can be used to render a digital representation, according to some examples of the present disclosure.

FIGS. 5A and 5B illustrate a method that illustrates optimizing a prior model and enrolling a user to utilize the canonical Gaussian template and the personalized Gaussian offsets of FIG. 4 to render a digital representation, according to some examples of the present disclosure.

FIG. 6 is a block diagram illustrating an example of a machine upon which one or more examples may be implemented.

FIG. 7 illustrates a device that can be used to implement exemplary examples of the present disclosure.

FIG. 8 is a method that illustrates optimizing a prior model and enrolling a user to utilize the canonical Gaussian template and the personalized Gaussian offsets of FIG. 4 to render a digital representation, according to some examples of the present disclosure.

FIGS. 9A and 9B are a method for generating a three-dimensional avatar of a person, according to some examples of the present disclosure.

FIG. 10 is a block diagram illustrating an example of a machine upon which one or more examples may be implemented.

### DETAILED DESCRIPTION

When NeRFs and Gaussian splatting are used to render digital representations, problems can occur with the rendered digital representations. In order to render high-quality digital representations, data from many different angles is required. Thus, NeRFs and Gaussian splatting require the use of multiple synchronized cameras to capture images, which can be cost prohibitive. Furthermore, if a single camera is used, significant quality degradation can occur when a digital representation is rendered from a view that minimally varies from a capture angle of the single camera. In order to show multiple views, such as if the user turns their head, in order to render different views of the user, such as a profile view of the user, multiple input views are required. Furthermore, if the user changes an expression, in order to capture the expression change, a long enrollment sequence is required.

Examples address the problems noted above by providing a system that can create a digital representation of a user and animate the digital representation based on an audio input and/or a visual input associated with the user. Examples can generate a synthesized views and synthesized expressions. The synthesized view can relate to receiving a single camera input and generating various 3D views from the single camera input. The implementation of synthesized views and expressions can allow for animation of an avatar associated with a user based on a single input from the user, which can be either a single audio input, a single video input, or a combination of a single video input and a single audio input.

A deep neural network (DNN) architecture based prior model can be trained to identify per-Gaussian features and capture similarities across a data set. This can be done in the context of images for different users. The similarities can relate to features that are common across the images of the different users, such as generic facial features, which can include eyes, a nose, and a mouth. During training, a canonical Gaussian template can then be generated based on the similarities.

An enrollment process can be performed where personalized Gaussian offsets can be determined for a user. The Gaussian offsets can relate to an offset relative to values at the canonical Gaussian template. The personalized Gaussian offsets can be used in conjunction with the canonical Gaussian template to generate a digital representation of a user by a prior model. In particular, the prior model can mesh the Gaussian offsets with the canonical Gaussian template to generate a 3D of a user.

An enrollment process that can include a plurality of stages can be performed. During a first stage of enrollment, an appearance vector is determined for a user. Here, various features of the user are being determined, such as skin tone, eye shape, hair length, and other identifying features associated with the user. The first stage can be performed to determine appearance vectors that can be used by a prior model to output a rendered 3D image that most closely matches a 2D image that represents the user.

During a second stage of enrollment, weights associated with the prior model are updated to close a domain gap. In particular, differences between the per-Gaussian features and the appearance vector are determined. These differences can be used to determine the personalized Gaussian offsets. At the second stage, a weight of the prior model can be optimized, thereby providing the prior model greater freedom to output Gaussian offsets that can be used to better represent the user in a 3D image. During a third stage, another fit is performed to further optimize the Gaussians and further refine a generated 3D image of a user.

At a later time, when the user desires to have an avatar implemented during a communication session, the canonical Gaussian template in conjunction with the personalized Gaussian offsets can be used to render the avatar. In particular, Gaussian splats, which can be created based on the canonical Gaussian template and the personalized Gaussian offsets, can be placed on a mesh-based representation in order to generate the avatar. Furthermore, the avatar can be animated during the communication session based on signals associated with the user, such as audio signals and/or visual signals, that are received during the communication session.

Examples address technical problems rooted in computer technology where examples provide technological solutions to technological problems specific to computer networks. A technical problem specifically arising in the realm of computer networks relates to generating avatars that resemble a user. Typically, multiple cameras are required to capture video inputs of the user where the video inputs are converted into an avatar. This can be resource intensive and time consuming. In particular, a computing device will require greater computing power in order to convert the multiple inputs into an avatar, thereby creating a technical problem for a computing device.

Examples decrease the computing resources necessary for rendering an avatar that resembles a user, thereby providing a technical solution to the technical problem described above. In particular, a first template can be generated that can correspond to generic features of various users and a second template in the form of personalized Gaussian offsets can be generated that corresponds to a specific user. A computing device can generate an avatar by utilizing the first template in combination with the second template using a single audio and/or visual input, thereby decreasing the computing resources necessary for rendering an avatar. Thus, examples improve the ability of a device to render an avatar by implementing offsets in combination with a canonical template.

Examples use components in an unconventional manner in order to improve computer functionality. More specifically, examples use these components to provide technical solutions that allow for the rendering of a three-dimensional avatar based on a two-dimensional input. Moreover, examples allow for the generation of a 360° view of an avatar with a single audio and/or visual input instead of requiring video inputs that encompass a 360° view of a user for which an avatar is being generated.

Examples are rooted in computing technology. An audio and/or visual input is converted into a Gaussian splat representation and then applied to a mesh-based representation. The input can be a two-dimensional input, which is input on a three-dimensional mesh-based representation. The input can also relate to an expression or a sound made by a user. The computing device can manipulate the mesh-based representation, which includes the Gaussian splats, to mimic the expression or the sound made by user for display by a computing device based on a received audio or visual input associated with the user.

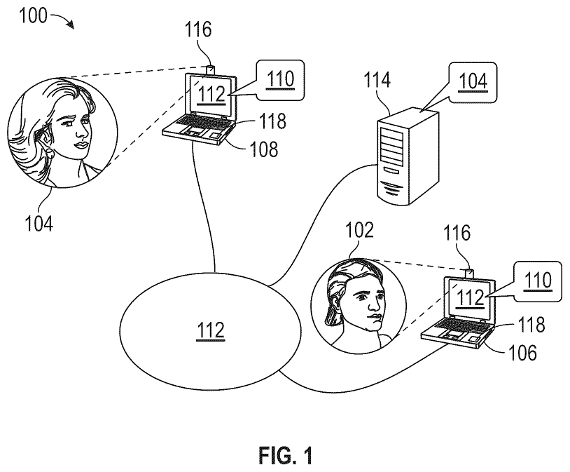

Now making reference to FIG. 1, an environment 100 in which examples may operate is shown. Users 102 and 104 respectively associated with user devices 106 and 108 can execute a network-based application, generically shown as 110, which can, via a network 112, provide access to a server device 114. The devices 106 and 108 and the server device 114 can include any type of computing device, such as a desktop computer, a laptop computer, a tablet computer, a portable media device, or a smart phone. The network 112 may be any network that enables communication between or among machines, databases, and devices (e.g., the user devices 106 and 108 and the server device 114). The network 112 can be a packet routing network that can follow the Internet Protocol (IP) and the Transport Control Protocol (TCP). Accordingly, the network 112 can be a wired network, a wireless network (e.g., a mobile or cellular network), or any suitable combination thereof. The network 112 can include one or more portions that constitute a private network, a public network (e.g., the Internet), or any suitable combination thereof.

The user devices 106 and 108 can include an image capture device 116 that can capture visual signals associated with the users 102 and 104. The visual signals can be a static two-dimensional image or a moving video image. The user devices 106 and 108 can also have a microphone 118, which can capture audio signals from the users 102 and 104. The audio signals can relate to speech or any type of sound made by the users 102 and 104 during a communication session.

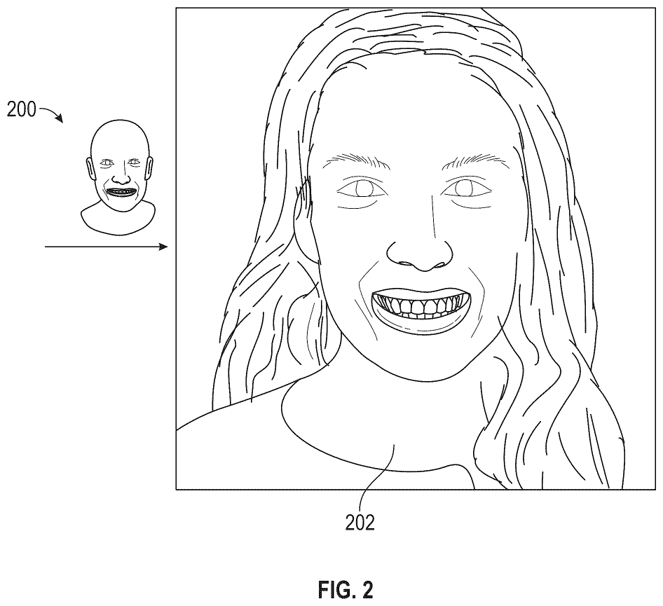

Examples can implement a mesh-based representation 200 to describe a surface of a 3D object, as shown with reference to FIG. 2. The mesh-based representation 200 can use a network of interconnected geometric elements and describe a shape and structure of 3D objects. The mesh-based representation 200 can include polygon meshes that can form a polyhedral shape that approximates a surface of a 3D object. The mesh-based representation 200 can include vertices that correspond to points in a 3D space having X, Y, and Z coordinates. The mesh-based representation 200 can include edges that connect pairs of the vertices. The connecting edges can form the polygon meshes for the polyhedral shape.

In order to generate a digital representation 202 Gaussians can be used where Gaussian splatting techniques can be used in conjunction with the mesh-based representation 200 where Gaussian splats can be applied to the mesh-based representation 200. The Gaussians can include various parameters such as position, covariance, color, opacity, and other relevant parameters. Gaussian splatting is a volume rendering technique that can be used to create three-dimensional images. Gaussian splatting can employ tiny, translucent ellipsoids known as Gaussian splats. The Gaussian splats can be ellipsoids that can have different lengths along their axis. The different lengths associated with the ellipsoids can allow for elongation or flattening of the Gaussian splats. Gaussian splatting can represent surface properties for a user associated with an avatar and provide surface detail. Surface detail can include various physical features of a user, such as hair style, hair color, facial features, and the like.

Gaussian splatting can be useful in rendering high-quality digital representations, such as photorealistic avatars, by leveraging the properties of Gaussian functions to smoothly interpolate and blend visual data. Gaussian splatting can be combined with techniques like NeRFs to enhance the rendering of 3D scenes from 2D images, thereby providing a more realistic and detailed visual output. The technique is advantageous in applications requiring real-time rendering and high visual fidelity, such as virtual reality, gaming, and video conferencing. When Gaussian splats are applied to the mesh-based representation 200, the digital representation 202 can be generated that can be a photorealistic representation of a user associated with an avatar that is participating in a communication. session. As discussed herein, references to a user or users can refer to a user or users that is/are associated with an electronic rendering, such as an avatar participating in a communication session.

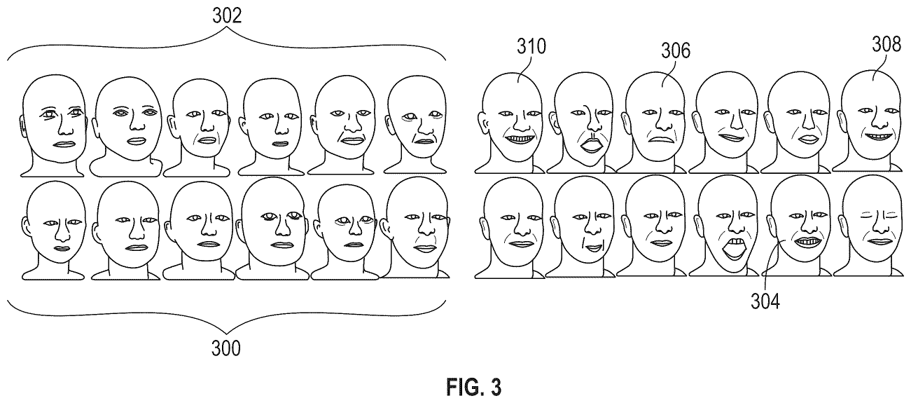

Different mesh-based representations 300-310 can be stored for different types of users, as shown with reference to FIG. 3. The mesh-based representations 300-310 can be generalized users where the mesh-based representations 300-310 can differ based on gender, ethnicity, age, physique, or any other differentiating feature. The mesh-based representations 304-310 can correspond to different expressions that a user may have during a communication session. The mesh-based representations 300-310 can be pre-stored, such as at the server device 114, and accessed during training and enrollment, as will be discussed further on. Gaussian splats can be applied to one of the mesh-based representations 300-310 when a user participates in a communication session.

Mesh-based representations can be animated based on a tracking signal received from the user, such as from the image capture device 116 or the microphone 118. The tracking signal can relate to an audio signal captured by the microphone 118 such as a user hearing unfavorable news and vocally expressing the receipt of the unfavorable news. A mesh-based representation can be animated based on the audio signal and the user hearing the unfavorable news, as shown with the mesh-based representations 304 and 306. The tracking signal can also relate to a visual input where the image capture device 116 captures an image. For example, when the user is smiling, such as hearing favorable news, the image capture device 116 can capture an image of the user smiling as a visual input. A mesh-based representation can be animated based on the user smiling, as shown with the mesh-based representations 308 and 310.

The tracking signal can be captured using a single input device, such as only the image capture device 116 or only the microphone 118. Furthermore, the tracking signal can be captured using both the image capture device 116 and the microphone 118. The mesh-based representations can be animated to correlate with the mesh-based representations 304-310 or any of the other mesh-based representations shown with reference to FIG. 3 after the Gaussian splats have been attached to a mesh-based representation to generate a digital representation, such as the digital representation 202. Therefore, a digital representation, such as the digital representation 202, can be animated according to expressions and sounds made by a user that is participating in a communication session and is associated with the digital representation.

As noted above, examples provide a system that can create a digital representation of a user and animate the digital representation based on an audio input and/or a visual input associated with the user. A system is trained to generate a prior model and a canonical Gaussian template based on an audio or visual input associated with a user. The prior model can be used to fill in various gaps of a 3D image not captured by a 2D image. An enrollment process can be performed where personalized Gaussian offsets can be determined for a user. The personalized Gaussian offsets can be used in conjunction with the canonical Gaussian template to generate a digital representation of a user in real time.

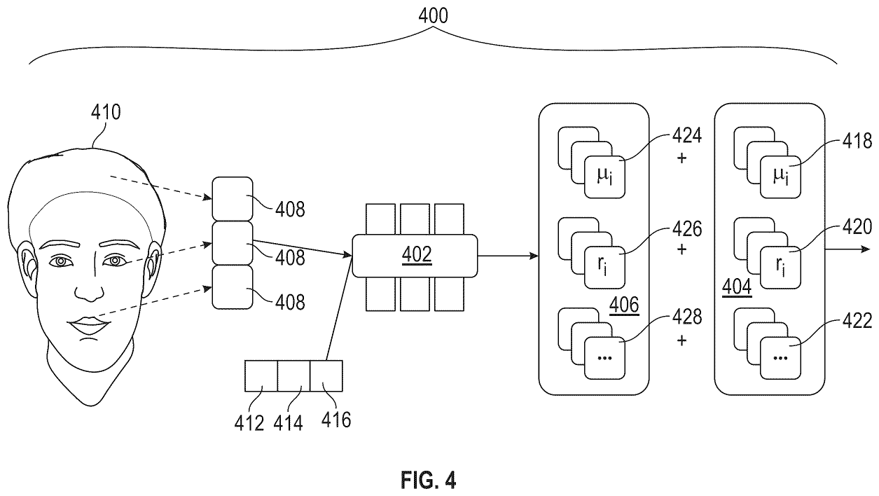

Now making reference to FIG. 4, a DNN based architecture 400 is shown, in which examples can be implemented. While the architecture 400 is described as being DNN based, the architecture 400 and the disclosure herein can be any type of architecture that implements any type of artificial intelligence (AI). These can include, but are not limited to, capability-based classification AI, functionality-based classification AI, machine learning, generative AI, and other types of deep learning. personalized Gaussian offsets 406

A prior model 402 can be a neural network with an initial set of assumptions relating to generating a digital representation associated with a user. Using a single input, which can be an audio input or a visual input, such as an image, the prior model 402 can be used to generate a full 360° digital representation of a user as a digital representation participating in a communication session. Thus, the prior model 402 can be used to generate a digital representation with limited input data.

The prior model 402 can be trained in two phases. In a first training phase, the prior model 402 can be trained to produce the correct Gaussian splats attached to a mesh, such as the mesh representation 200. In the first training phase, the prior model 402 can be trained on large amounts of multi-view data. During the first training phase, the prior model 402 can be trained to discern correlations between various features for users. To further illustrate, during the first training phase, the prior model 402 can be trained that a skin tone for a user at first area, such as on a forehead, can be the same as the skin tone at another area, such as the back of the neck of the user.

During the first training phase, the prior model 402 can learn latent appearance vectors, which can correspond to appearance vectors that are compressed representations of identity-related features. The latent appearance vectors can be a compact quantitative way of describing an appearance of a user.

Armed with this knowledge, the prior model 402 can correctly generate a view of the user not visible at a single input. To further illustrate, the prior model 402 can generate a view of the back of the neck of a user having the correct skin tone with only a view of the skin tone of the forehead of the user. Therefore, the prior model 402 can be trained to produce a Gaussian avatar for a user participating in a communication session.

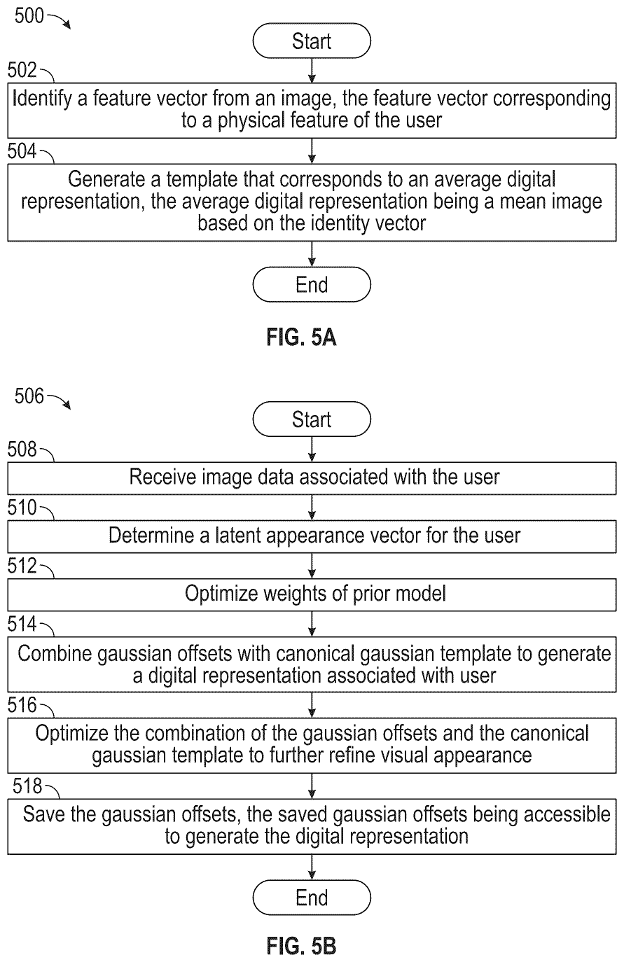

A canonical Gaussian template 404 can be used in conjunction with the personalized Gaussian offsets 406 to generate the digital representation of a user, as will be discussed in greater detail further on with respect to FIG. 5. The prior model 402 can relate the feature vectors 408 to the canonical Gaussian template 404 in combination with the personalized Gaussian offsets 406. The feature vectors 408 can be per-Gaussian semantic features and can relate 3D Gaussians to physical characteristics of a user, such as skin tone, hair length, facial hair length, eye shape, eye color, nose shape, nose, neck length, neck width, or any other physical characteristic of a user. Thus, the feature vectors 408 can have the same semantic meaning for all users.

The canonical Gaussian template 404 in combination with the personalized Gaussian offsets 406 and can be used to render digital representation 410 in 3D for a user associated with the personalized Gaussian offsets 406. By virtue of the canonical Gaussian template 404 and the personalized Gaussian offsets 406 storing data relating to 3D Gaussians, 360° views of digital representations that are generated with the canonical Gaussian template 404 and the personalized Gaussian offsets 406 can be rendered and displayed on the user devices 106 and 108 in real time.

The personalized Gaussian offsets 406 can be determined during an enrollment process where Gaussian offsets for a user can be determined. The Gaussian offsets 406 can relate to an offset relative to values at the canonical Gaussian template 404, as mentioned above. After the enrollment process the canonical Gaussian template 404 and the personalized Gaussian offsets 406 can be combined into a single set of 3D Gaussians, which are sufficient to render the digital representation of the user 410. Since this set of 3D Gaussians allows for quick generation of digital representations, they can improve the functioning of a computing device by reducing computational resources needed for rendering digital representations while at the same time improving the speed with which a computing device can render digital representations. This is a distinct benefit when the user desires to join a communication session and have a digital representation for the communication session, for example.

Now making reference to FIGS. 5A and 5B, the operations discussed with reference thereto can be performed with a system having a computing device, such as the server device 114, or the like. The operations in the method 500 can be performed during two separate and distinct phases, a training phase, as shown in FIG. 5A and an enrollment phase, as shown in FIG. 5B. During the training phase, operations 502 and 504 can be performed where a canonical Gaussian template can be generated. During the enrollment phase, operations 506-514 can be performed, where Gaussian offsets for a user can be determined and saved as a personalized Gaussian offsets template.

During the operation 502, the system can be trained to identify per-Gaussian semantic features. As used herein, a per-Gaussian semantic feature can also be referred to as a feature vector. Per-Gaussian semantic features can capture similarities across a data set. For example, if a data set relates to 3D images of the head of different people, the similarities can relate to the fact that all the heads have a face, eyes, a nose, cheeks, and the like. Thus, per-Gaussian semantic features can enforce consistency among different users, such as each of the users have eyes, nose, and cheeks in the same general area of their respective face. Furthermore, during the training period, the prior model can learn that per-Gaussian features can remain consistent at different areas. To further illustrate, during the operation 502, a determination can be made that a skin tone for the cheek of users remains consistent on both the left cheek and the right cheek. Similarly, this type of learning can be applied to other areas, such as the back of a neck of a user when only the front of the neck is acquired in a 2D image. Thus, various features can be semantically aligned across users where the generic correlations across a data set, such as a person, are being determined. With this knowledge, a 3D model can be constructed having left and right cheeks when a color for only the left cheek is known. Moreover, per-Gaussian semantic features can remain the same after the training period.

After the per-Gaussian semantic features are identified, an operation 504 can be performed where a template that corresponds to an average digital representation can be generated. The average digital representation can be mean image data based on the per-Gaussian semantic features. The template generated at the operation 504 can be the canonical Gaussian template 404. As discussed above, the canonical Gaussian template 404 can relate to a mean appearance of users associated with digital representations participating in a communication session. The mean appearance can relate to an average magnitude of the per-Gaussian semantic features.

The operations 502 and 504 can be repeated until the canonical Gaussian template 404 is optimized. In examples, the prior model 402 and the canonical Gaussian template 404 can be optimized according to the following loss function:

$$L = {λ}_{pix} {L}_{pix} + {λ}_{α} {L}_{α} + {λ}_{percep} {L}_{percep} + {L}_{reg} \qquad ( Equation 1 )$$

Lₚᵢₓ can be a pixel level loss having L₁, which can be a [symbol] ₁ difference between real and predicted images and L_{SSIM} which can be the differentiable Structural Similarity Index (SSIM) loss, weighted by λ₁ and λ_{SSIM} respectively. The SSIM is a loss function that measures the similarity between two images. SSIM is a perceptual metric that quantifies image quality degradation caused by processing, such as compression or noise. SSIM can be used in gradient-based optimization processes. By incorporating SSIM into the loss function, the prior model 402 can be trained to produce digital representations that are not only numerically similar to the target images but also perceptually similar, thereby providing visual results having increased accuracy and quality. λpix, λα, and λpercep relate to the weights of those terms within the loss.

L_{percep} can be a perceptual loss based on a Learned Perceptual Image Patch Similarity (LPIPS), L_{α} is the [symbol] ₁ distance between the real and predicted alpha masks, and L_{reg} is a regularization loss acting on the Gaussians as shown below. Scale and displacement can be regularized as follows:

$${L}_{r e g} = {λ}_{σ} {‖ max ( 0.6 , {σ}^{′} ) ‖}_{2} + {λ}_{μ} {‖ {μ}^{′} ‖}_{2} \qquad ( Equation 2 )$$

λ_{σ} and λ_{μ} can relate to weights of the terms in Equation 2.

LPIPS compares deep features extracted from images using a pre-trained convolutional neural network (CNN). The deep features can be more representative of high-level visual information, such as textures and structures, as opposed to only pixel values. By comparing deep features, LPIPS can provide a measure of similarity that reflects how humans perceive differences between images.

Now making reference to FIG. 5B, after the template is generated, the enrollment phase can begin. The enrollment phase can relate to determining personalized Gaussian offsets for a particular user at a first time period T₁. Thus, at a second time period T₂ after the first time period T₁, when a digital representation is to be generated for the user, the personalized Gaussian offsets can be accessed and, in conjunction with the canonical Gaussian template 404, a digital representation can be generated.

During an operation 508, image data associated with the user can be received. The image data can correspond to a static 2D image of the user. The image data can also correspond to a video of the user. After receipt of the image data, latent appearance vectors can be determined for a user during an operation 510. The latent appearance vectors can relate to how a per-Gaussian feature appears for a particular user. Thus, latent appearance vectors can vary among different users and therefore be specific for a given user. The latent appearance vectors can be combined with the per-Gaussian features to generate a 3D image of the user. The latent appearance vectors can be determined through optimization using image reconstruction loss where the prior model and the canonical template remain fixed as the latent appearance vectors are determined. Image reconstruction loss can involve measuring a difference between the 2D image and the generated 3D image in order to minimize any losses between the 2D image and the generated 3D image. An image loss reconstruction function can be used, which can include Mean Squared Error, Mean Absolute Error, Structural Similarity Index, and Learned Perceptual Image Patch Similarity.

During an operation 512, the weights of the prior model 404 can be optimized to close a domain gap. Any differences between the per-Gaussian features and the latent appearance vectors are determined. These differences can be used to determine the personalized Gaussian offsets. The weights can be optimized in order to provide the prior model 404 greater freedom to output Gaussian offsets that can be used to better represent the user in a 3D image.

After the weights of the prior model are optimized, a digital representation can be generated during an operation 514. In particular, the personalized Gaussian offsets 406 can be combined with the canonical Gaussian template 404 to generate a digital representation. The combination of the Gaussian offsets 406 and the canonical Gaussian template 404 can be optimized during an operation 516 in order to refine a visual appearance of the user. In the data set example above relating to 3D images of the head of different users, the latent appearance vectors can relate to the color of the eyes of the user, the color of the cheeks of the user, the shape of the face of the user, and the shape of the nose of the user. Thus, the latent appearance vectors can be specific to the user and various characteristics of the user.

Furthermore, the Gaussian offset can be saved in a database during an operation 516 such that the Gaussian offset can be accessed at a later time when the user associated with the Gaussian offset desires to have a digital representation generated. In particular, the Gaussian offset can be saved as the personalized Gaussian offsets 406 during the operation 516.

In the data set example above relating to 3D images of the head of different users, the latent appearance vectors can relate to the color of the eyes of the user, the color of the cheeks of the user, the shape of the face of the user, and the shape of the nose of the user. Thus, the latent appearance vectors can be specific to the user and various characteristics of the user.

The latent appearance vectors can correspond to a magnitude for the feature vector where the magnitude can relate to a value for the same characteristic among different users. A magnitude can vary for different users. In particular, when the latent appearance vector relates to hair length, facial hair, and eyebrows, these can vary for different users. Thus, the latent appearance vectors can be different. The latent appearance vectors can be assigned a magnitude, such as a numerical value.

When comparing the latent appearance vectors with the per-Gaussian semantic features during the operation 512, the magnitudes of the per-Gaussian features can be compared with the magnitudes for the latent appearance vectors. This can be done by comparing the image received during the operation 508 with an image rendered using the canonical Gaussian template 404. Adjustments can be made to the magnitudes until a rendered image matches the image received during the operation 508. A match can be determined using a loss function, as previously described.

The method 506 can be repeated for additional users. Thus, a second Gaussian offset can be determined for a second user when the operations 508-516 are repeated for a second user. Here, image data would be received for the second user and comparted with the average digital representation generated with the canonical Gaussian template 404 during the operations 508 and 510. During the operation 512, the average digital representation can be compared with the image data for the second user and the average magnitude for the average digital representation can be adjusted as discussed above. A difference between the average magnitude and the adjusted magnitude, where the difference can correspond to the second Gaussian offset, can be determined during the operation 516 and then stored during the operation 518, as discussed above.

When a digital representation of a user, such as the user 102, is rendered at a later time using the canonical Gaussian template 404 and the personalized Gaussian offsets 406 in conjunction with one of the mesh-based representations 300-310, the digital representation can be animated based on a signal received the image capture device 116 and/or the microphone 118. For example, if the user 102 begins speaking during a communication session with the user 104 where the user 102 is represented by a digital representation, the digital representation can be animated based on an audio signal received at the microphone 118 at the user device 106. Moreover, the digital representation for the user 102 can be animated based on a single visual input received at the image capture device 116 at the user device 106.

Likewise, a second user, such as the user 104 in the communication session, can also be animated based on an audio signal received at the microphone 118 at the user device 108. Similarly, the digital representation for the user 104 can be animated based on a single visual signal received at the image capture device 116 at the user device 108. As such, a single input can be used to animate a digital representation instead of multiple inputs, thereby minimizing the computing resources of the server device 114 that animates the digital representation. The digital representations of the users 102 and 104 can be displayed on the user device 106. In addition, the animated digital representations of the users 102 and 104 can be displayed on the user device 108.

Furthermore, by virtue of the canonical Gaussian template 404 and the personalized Gaussian offsets 406, the image capture device 116 can capture a two-dimensional image and the server device 114 can render a 3D image, which can be the digital representation. Additionally, since the server device 114 generates the digital representation and can animate the digital representation, examples are tied to a computing device.

In further examples, the personalized Gaussian offsets can be changed at a later time. For example, at a time T₁, a user may have a beard and shoulder length hair and the offsets are determined for the user at the time T₁. However, at a later time T₂, the user may have a clean-shaven face along with hair that does not extend pass beyond the cars of the user. Instead of having to repeat an enrollment process, the user can provide an updated photo the system or simply provide a description of the changes in text format. Using the updated photo or the text description of the changes, the system can adjust the offsets to reflect the clean-shaven face and the short hair.

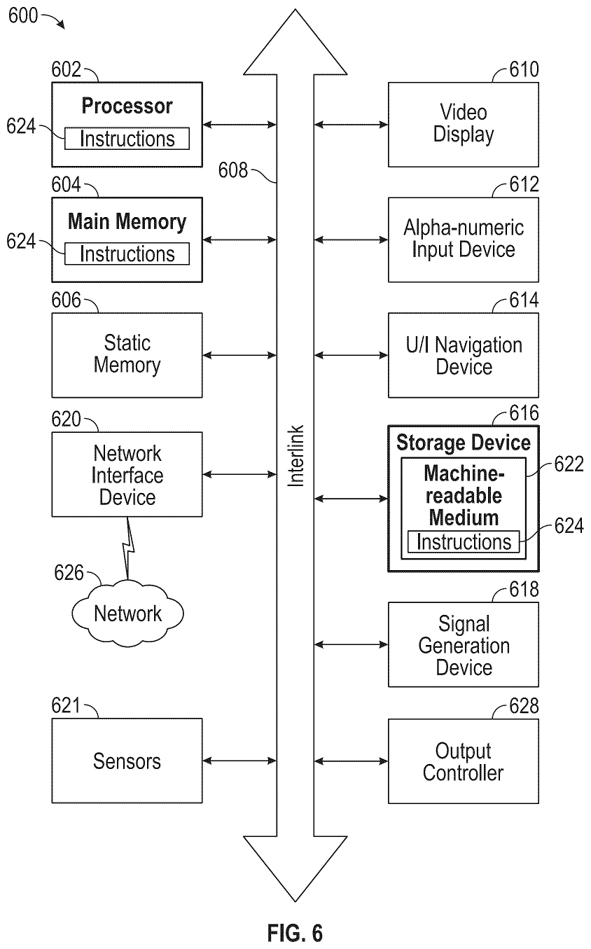

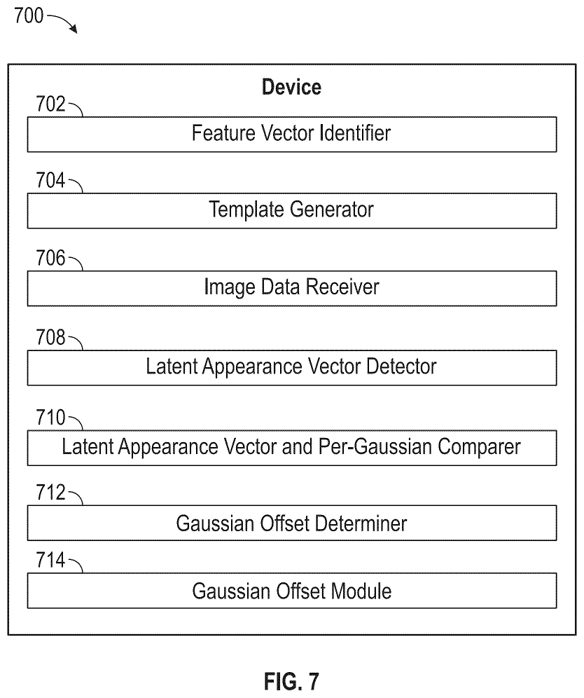

FIG. 6 illustrates a block diagram of an example machine 600 upon which any one or more of the techniques (e.g., methodologies) discussed herein may be performed. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The memory machine 600 may be in the form of a server computer, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. The machine 600 may be configured to provide the functionality of the various devices described with reference to FIG. 1; separating a feature vector from an image; associating an appearance vector with the feature vector; generating a canonical Gaussian template that corresponds to an average digital representation; receiving image data associated with a user; rendering the average digital representation using the canonical Gaussian template; comparing the average digital representation with the image data; adjusting an average magnitude associated with an appearance vector of the average digital representation based on the comparison; determining a difference between the average magnitude and the adjusted magnitude where the difference corresponds to a Gaussian offset; and saving the Gaussian offset such that the Gaussian offset is accessible to render a digital representation. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

The machine (e.g., computer system) 600 may include one or more hardware processors, such as a processor 602. The processor 602 may be a central processing unit (CPU), a graphics processing unit (GPU), a hardware processor core, or any combination thereof. The machine 600 may include a main memory 604 and a static memory 606, some or all of which may communicate with each other via an interlink (e.g., bus) 908. Examples of main memory 604 may include Synchronous Dynamic Random-Access Memory (SDRAM), such as Double Data Rate memory, such as DDR4 or DDR5. The interlink 608 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

A storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine-readable media. In some examples, machine-readable media may include machine-readable media that is not a transitory propagating signal.

The instructions 624 may further be transmitted or received over a communications network 626 using a transmission medium via the network interface device 620. The machine 600 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. In some examples, the network interface device 620 may wirelessly communicate using Multiple User MIMO techniques.

In addition, examples can include a device 700 having components to achieve the features disclosed herein. The device 700 may be an example configuration of machine 600—e.g., through hardware or software. For example, the device 700 can include a feature vector separator 702 that can function to separate a feature vector from an image. The separated feature vector can correspond to a physical feature of a user.

Moreover, the device 700 can have template generator 704, which can generate templates as detailed above.

The device 700 can also include an image data receiver 706 that functions to receive image data associated with a user. Additionally, the device 700 can include latent appearance vector detector 708 that can detect.

Furthermore, the device 700 can have a latent appearance vector and per-Gaussian comparer 712. The average digital representation and image data comparer 712 can compare latent appearance vectors with per-Gaussians the average digital representation with the image data as described above.

The device 700 can also have a Gaussian offset determiner 712 that functions to determine a difference between the average magnitude and the adjusted average magnitude. The difference can correspond to a Gaussian offset. In addition, the device 700 can have a Gaussian offset module 714, which can function to store Gaussian offsets.

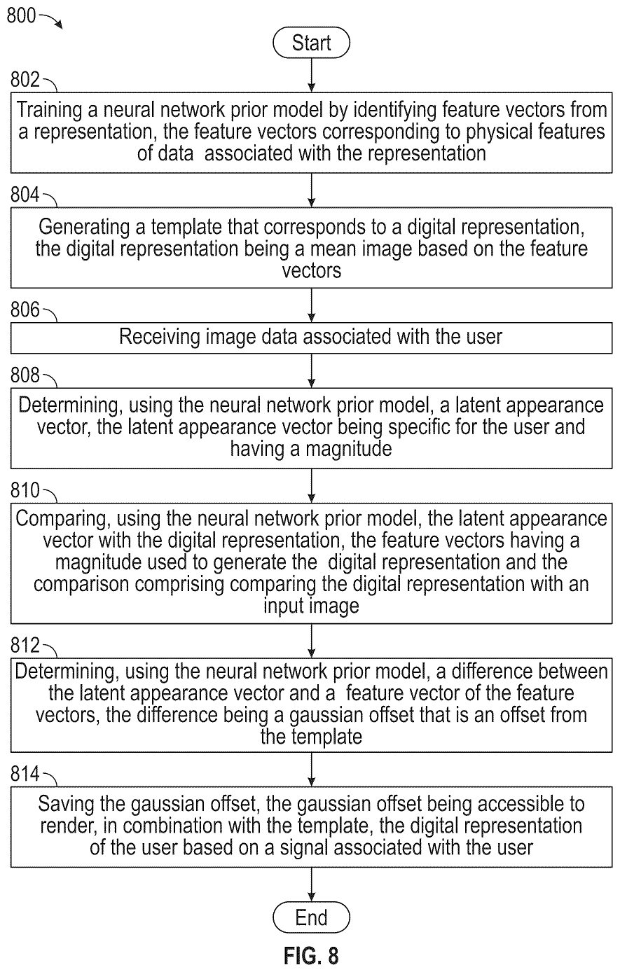

Now making reference to FIG. 8, a method 800 for generating a gaussian offset to render a digital representation of a user is provided. During an operation 802, a neural network prior model is trained by identifying feature vectors from a representation, the feature vectors corresponding to physical features of data associated with the representation. A template that corresponds to a digital representation, the digital representation being a mean image based on the feature vectors is then generated during an operation 804.

An image data associated with a user can be received during an operation 806. Upon receiving the image data, using the neural network prior model, a latent appearance vector, the latent appearance vector being specific for the user and having a magnitude can be determined during an operation 808. The neural network model can then be used to compare the latent appearance vector with the digital representation, the feature vectors having a magnitude used to generate the digital representation and the comparison comprising comparing the digital representation with an input image during an operation 810.

During an operation 812, a difference between the latent appearance vector and a feature vector of the feature vectors, the difference being a gaussian offset that is an offset from the template can be determined using the neural network model. The Gaussian offset can then be saved, where can be accessible to render, in combination with the template, the digital representation of the user based on a signal associated with the user during an operation 814.

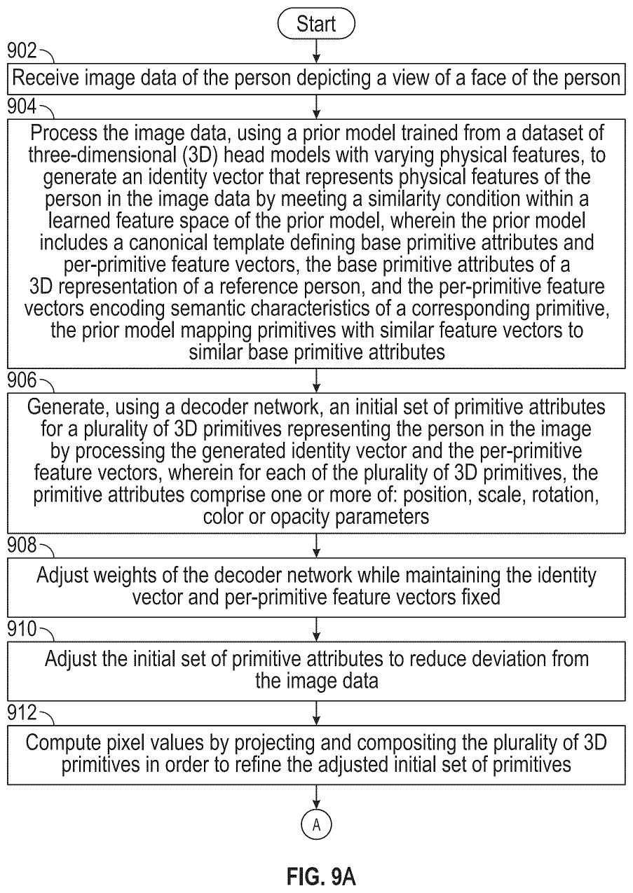

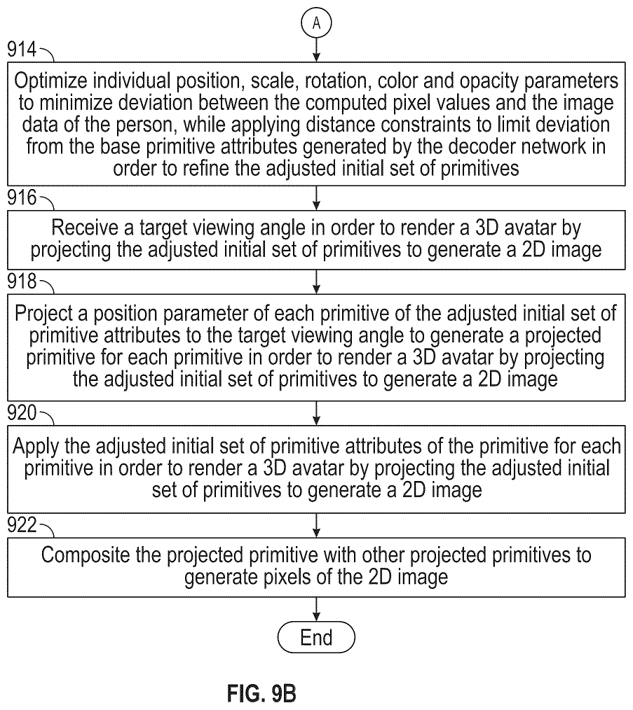

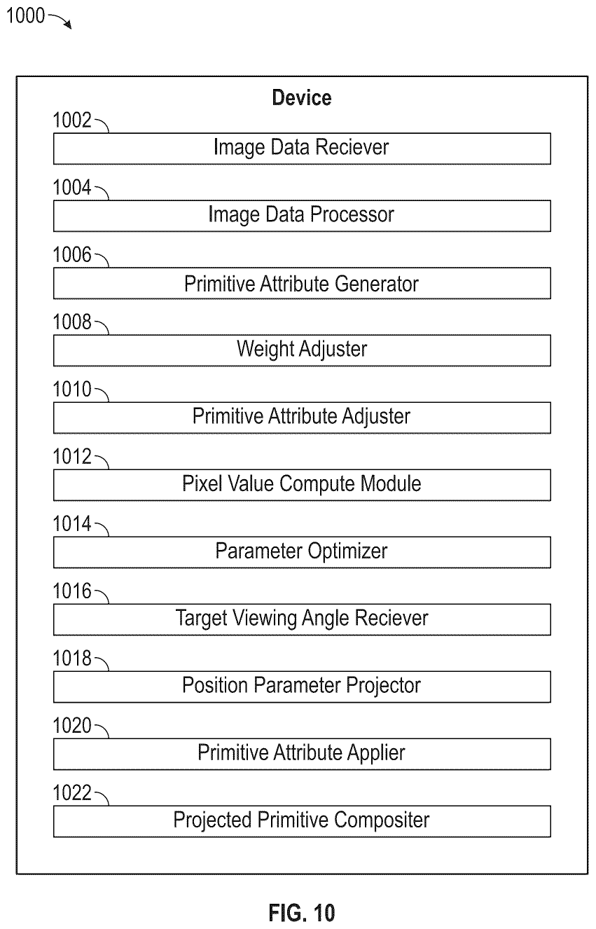

Now making reference to FIG. 9, a method 900 for generating a three-dimensional avatar of a person is shown. Initially, an operation 902 is performed where image data depicting a view of a face of a person is received. The image data can then be processed during an operation 904 using a prior model trained from a data set of 3D head models as described above. The 3D head models can have varying physical features, such as skin tone, facial structure, hair features, and the like. The image data can be processed to generate an identity vector that represents the physical features of in the image data. The identity vector can also have the attributes as described above. At the operation 904, the identity vector can be generated by meeting a similarity within a learned feature space of the prior model.

The learned feature space can refer to semantic relationships and correlations between per-primitive feature vectors that are learned during the training of the prior model. Per-primitive feature vectors can be 8-dimensional vectors that can encode semantic meanings for Gaussian primitives, such as ellipsoids, in an avatar model. The feature space can capture semantic correlations between primitives representing similar physical characteristics and relationships between features across different parts of the face/head. The feature space can also capture consistent meanings for features across different users. The learned feature space enables prediction of attributes for unseen regions based on visible regions with similar features. The learned feature space can also enable the transfer of properties between semantically similar areas along with preserving feature relationships during animation and rendering.

Still sticking with operation 904, the prior model can include a canonical template as described above. Here, the canonical template can define base primitive attributes and per-primitive feature vectors. The base primitive attributes can relate to a 3D representation of a reference person. Moreover, the base primitive attributes can define properties and characteristics of each 3D Gaussian. The base primitive can include the position parameters that can define where a primitive is located in 3D space. The base primitive can also include scale parameters that can control a size and dimensions of the primitive. Moreover, the base primitive can include rotation parameters, color parameters, and opacity parameters. The rotation parameters can determine how the primitive is oriented. The color parameters can define a visual appearance while the opacity parameters can control transparency and visibility. The per-primitive feature vectors can encode semantic characteristics of a corresponding primitive. Furthermore, the prior model can map primitives with similar feature vectors to similar base primitive attributes.

During an operation 906, the method 900 can generate an initial set of primitive attributes using a decoder network, such as the DNN described above. The primitive attributes can be for a plurality of 3D primitives that represent the person in the image. In order to achieve the representation of the person, the generated identity vector and the per-primitive feature vectors can be processed, wherein for each of the plurality of 3D primitives, the primitive attributes comprise one or more of: position, scale, rotation, color or opacity parameters.

After the operation 906, the method 900 performs an operation 908 where weights of the decoder network are adjusted while maintaining the identity vector and the per-primitive feature vectors fixed. This can be accomplished as discussed above with reference to FIG. 4.

The method 900 can then adjust the initial set of primitives to reduce deviation from the image data during an operation 910 and refine the adjusted initial set of primitives during operations 912 and 914. The initial set of primitives can be adjusted by fine-tuning the DNN, minimizing deviation using a loss function as described above, applying regulation constraints, computing pixel values during the operation 912, and optimizing individual primitive attributes during the operation 914. The DNN can be fine-tuned by performing the operation 908 and using an Adam optimizer with a learning rate of 0.0002. The DNN can also be fine-tuned by processing five-hundred optimization steps.

Regulation constraints can be applied through scale regularization on primitive scale parameters and displacement regularization on primitive position parameters. Regulation constraints can also be applied through scale regularization on L2 distance constraints between optimized attributes and DNN outputs.

During the operation 912, the pixel values can be computed by projecting a position of a primitive to a target viewing angle in order to refine the adjusted set of primitives. Primitive attributes, which can include position, scale, rotation, color, and opacity can be applied and then the projected primitives can be composting. Compositing can also be done in order to refine the adjusted set of primitives. Compositing can involve combining multiple 3D Gaussian primitives to generate final rendered pixels of a 2D image. This can include depth-sorted blending where primitives are combined based on their relative depths. Depth-sorted blending can also include weighting each the contribution of each primitive by an opacity parameter associated with each primitive. For each pixel color, compositing can include processing primitives in depth order and applying alpha blending using opacity parameters. Compositing can also include using smooth blending to create smooth, continuous surfaces.

During the operation 914, individual position, scale, rotation, color and opacity parameters can determined and optimized in order to minimize deviation. Deviation minimization can be accomplished by projecting a position of a primitive to a target viewing angle and applying position, scale, rotation, color, and opacity parameters in depth order. A rendered output can then be compared against image data received during the operation 902. Loss functions and regularization constraints as described above can then be applied. An Adam optimizer can then be used during the optimization process while multiple optimization steps are processed until convergence. This can be performed while maintaining semantic relationships between the position, scale, rotation, color, and opacity parameters. Optimization can use a differentiable rendering pipeline that can allow computing gradients through projection and compositing operations (described above) in order to adjust the position, scale, rotation, color, and opacity parameters while maintaining semantic consistency.

After the operation 914, the method 900 can perform operations 916-920. The operations 916-920 can be performed by projecting the adjusted initial set of primitives to generate a 2D image in order to render a 3D avatar. During the operation 916, a target viewing angle is received. During the operation 918, a position parameter of each primitive of the adjusted initial set of primitive attributes is projected to the target viewing angle. During the operation 920, the adjusted initial set of the primitive attributes is applied for each primitive.

During an operation 922, the projected primitive is composited with other projected primitives in order to generate pixels of the 2D image. Compositing can be performed as described above.

Examples can also include a device 1000 having components to achieve the features disclosed herein. The device 1000 may be an example configuration of machine 600—e.g., through hardware or software.

Examples can also include a device 1000 having components to achieve the features disclosed herein. The device 1000 may be an example configuration of machine 600—e.g., through hardware or software. The device 1000 can include a image data receiver 1002 that can receive image data depicting a view of a face of a person. The device 1000 can also have an image data processor 1004 that can process image data using a prior model. The prior model used by the image data processor can have the features described above. The image data processor 1004 can generate an identity vector that represents the physical features of in the image data where the identity vector meets a similarity within a learned feature space of the prior model.

The device 1000 also includes a primitive attribute generator 1006 that can generate an initial set of primitive attributes using a decoder network, such as the DNN described above and also with respect to the operation 906. In addition to the primitive attribute generator 1006, the device 1000 has a weight adjuster 1008. The weight adjuster 1008 can adjust weights of the decoder network while maintaining the identity vector and the per-primitive feature vectors fixed, as discussed above with reference to the operation 908.

Moreover, the device 1000 can have a primitive attribute adjuster 1010 that can adjust an initial set of primitives to reduce deviation from the image data as detailed above with reference to the operation 910. In addition to the primitive attribute adjuster 1010, the device 1000 can have a pixel value compute module 1012 and a parameter optimizer 1014. The pixel value compute module 1012 can compute pixel values as previously described with respect to the operation 912. The parameter optimizer 1014 can determine and optimize various parameters as detailed above with reference to the operation 914.

The device 1000 also has a target viewing angle receiver 1016 that can receive a target viewing angle. Furthermore, the device 1000 can include a position parameter projector 1018 that can project an adjusted initial set of primitive attributes to the target viewing angle received by the target viewing angle receiver 1016. A primitive attribute applier 1020 of the device 1000 can apply the adjusted initial set of the primitive attributes for each primitive. The device 1000 also includes a projected primitive compositor 1022 that can composite projected primitives with other projected primitives in order to generate pixels for a 2D image.

### Other Notes and Examples

Example 1 is a method for generating a three-dimensional avatar of a person, comprising: receiving image data of the person depicting a view of a face of the person; processing the image data, using a prior model trained from a dataset of three-dimensional head models with varying physical features, to generate an identity vector that represents physical features of the person in the image data by meeting a similarity condition within a learned feature space of the prior model, wherein the prior model includes, a canonical template defining base primitive attributes and per-primitive feature vectors, the base primitive attributes of a 3D representation of a reference person, and the per-primitive feature vectors encoding semantic characteristics of a corresponding primitive, the prior model mapping primitives with similar feature vectors to similar base primitive attributes; generating, using a decoder network, an initial set of primitive attributes for a plurality of three-dimensional primitives representing the person in the image by processing the generated identity vector and the per-primitive feature vectors, wherein for each of the plurality of three-dimensional primitives, the primitive attributes comprise one or more of: position, scale, rotation, color or opacity parameters; adjusting weights of the decoder network while maintaining the identity vector and per-primitive feature vectors fixed; adjusting the initial set of primitive attributes to reduce deviation from the image data; refining the adjusted initial set of primitive attributes by: computing pixel values by projecting and compositing the plurality of three-dimensional primitives; and optimizing individual position, scale, rotation, color and opacity parameters to minimize deviation between the computed pixel values and the image data of the person, while applying distance constraints to limit deviation from the base primitive attributes generated by the decoder network; rendering the three-dimensional avatar by projecting the adjusted initial set of primitive attributes to generate a two-dimensional image, wherein the projecting comprises: receiving a target viewing angle; and for each primitive: projecting a position parameter of each primitive of the adjusted initial set of primitive attributes to the target viewing angle to generate a projected primitive; applying the adjusted initial set of primitive attributes of the primitive; and compositing the projected primitive with other projected primitives to generate pixels of the two-dimensional image.

In Example 2, the subject matter of Example 1 includes, wherein the method further comprises training the prior model that comprises: generating synthetic training data including multiple three-dimensional head models with varying physical features where generating the synthetic training data includes: randomly generating a plurality of identities with different features; illuminating each identity of the plurality of identities with uniform white lighting; rendering multiple views of each head model to create training images; and optimizing the prior model to predict primitive attributes that reconstruct the training images.

In Example 3, the subject matter of Examples 1-2 includes, wherein the method further comprises training the prior model that comprises: optimizing a loss function that includes pixel-level loss, perceptual loss, alpha mask loss, and regularization loss components, where optimizing the regularization loss components comprises: applying scale regularization to primitive scale parameters; and applying displacement regularization to primitive position parameters.

In Example 4, the subject matter of Examples 1-3 includes, wherein the method further comprises training the prior model that comprises learning semantic correlations between per-primitive feature vectors where primitives with similar semantic features are mapped to similar attributes.

In Example 5, the subject matter of Examples 1-4 includes, wherein the method further comprises training the prior model that comprises: learning a canonical Gaussian template representing mean avatar primitive attributes; and modeling per-identity variations as offsets from the canonical template.

In Example 6, the subject matter of Examples 1-5 includes, wherein fine-tuning the decoder network comprises minimizing image reconstruction loss between an output rendered with the trained prior model and an input image by: computing color and opacity for pixel values associated with the rendered output and the input image by: projecting rendered output primitives and input image primitives at an angle; applying attributes of the rendered output primitives to the projected rendered output primitives, the rendered output primitives attributes being one of the scale, the rotation, the color, and the opacity; applying attributes of the input image primitives to the projected input image primitives, the input image primitive attributes being one of the scale, the rotation, the color, and the opacity; and blending projected rendered output primitives with the projected input image primitives.

In Example 7, the subject matter of Examples 1-6 includes, wherein refining the adjusted initial set of primitive attributes by computing pixel values by projecting the plurality of three-dimensional primitives includes: computing color and opacity for pixel values associated with the projected plurality of three-dimensional primitives by: projecting the plurality of three-dimensional primitives and input image primitives of the input image data at an angle; applying attributes to the plurality of three-dimensional primitives projected at the angle, the attributes applied to the plurality of three-dimensional primitives projected at the angle being one of the scale, the rotation, the color, and the opacity; applying attributes of the input image primitives to the projected input image primitives, the input image primitive attributes being one of the scale, the rotation, the color, and the opacity; and blending the plurality of three-dimensional primitives projected at the angle with the projected input image primitives.

In Example 8, the subject matter of Examples 1-7 includes, wherein generating the initial set of primitive attributes comprises: concatenating a per-primitive feature vector of each of the initial set of primitive attributes with the identity vector; processing the concatenated per-primitive feature vectors through linear layers having a fixed number of dimensional outputs; and generating separate attribute outputs.

In Example 9, the subject matter of Example 8 includes, wherein the fixed number of dimensional outputs is 256.

In Example 10, the subject matter of Examples 1-9 includes, wherein the decoder network is trained by optimizing a loss function including pixel-level loss, perceptual loss, alpha mask loss, and regularization loss.

Example 11 is a computing device for generating a three-dimensional avatar of a person, the computing device comprising: a processor; a memory, storing instructions, which when executed by the processor cause the computing device to perform operations comprising: receiving image data of the person depicting a view of a face of the person; processing the image data, using a prior model trained from a dataset of three-dimensional head models with varying physical features, to generate an identity vector that represents physical features of the person in the image data by meeting a similarity condition within a learned feature space of the prior model, wherein the prior model includes, a canonical template defining base primitive attributes and per-primitive feature vectors, the base primitive attributes of a 3D representation of a reference person, and the per-primitive feature vectors encoding semantic characteristics of a corresponding primitive, the prior model mapping primitives with similar feature vectors to similar base primitive attributes; generating, using a decoder network, an initial set of primitive attributes for a plurality of three-dimensional primitives representing the person in the image by processing the generated identity vector and the per-primitive feature vectors, wherein for each of the plurality of three-dimensional primitives, the primitive attributes comprise one or more of: position, scale, rotation, color or opacity parameters; adjusting weights of the decoder network while maintaining the identity vector and per-primitive feature vectors fixed; adjusting the initial set of primitive attributes to reduce deviation from the image data; refining the adjusted initial set of primitive attributes by: computing pixel values by projecting and compositing the plurality of three-dimensional primitives; and optimizing individual position, scale, rotation, color and opacity parameters to minimize deviation between the computed pixel values and the image data of the person, while applying distance constraints to limit deviation from the base primitive attributes generated by the decoder network; rendering the three-dimensional avatar by projecting the adjusted initial set of primitive attributes to generate a two-dimensional image, wherein the projecting comprises: receiving a target viewing angle; and for each primitive: projecting a position parameter of each primitive of the adjusted initial set of primitive attributes to the target viewing angle to generate a projected primitive; applying the adjusted initial set of primitive attributes of the primitive; and compositing the projected primitive with other projected primitives to generate pixels of the two-dimensional image.

In Example 12, the subject matter of Example 11 includes, wherein the operations further comprise training the prior model that comprises: generating synthetic training data including multiple three-dimensional head models with varying physical features where generating the synthetic training data includes: randomly generating a plurality of identities with different features; illuminating each identity of the plurality of identities with uniform white lighting; rendering multiple views of each head model to create training images; and optimizing the prior model to predict primitive attributes that reconstruct the training images.

In Example 13, the subject matter of Examples 11-12 includes, wherein the operations further comprise training the prior model that comprises: optimizing a loss function that includes pixel-level loss, perceptual loss, alpha mask loss, and regularization loss components, where optimizing the regularization loss components comprises: applying scale regularization to primitive scale parameters; and applying displacement regularization to primitive position parameters.

In Example 14, the subject matter of Examples 11-13 includes, wherein the operations further comprise training the prior model that comprises learning semantic correlations between per-primitive feature vectors where primitives with similar semantic features are mapped to similar attributes.

In Example 15, the subject matter of Examples 11-14 includes, wherein the operations further comprise training the prior model that comprises: learning a canonical Gaussian template representing mean avatar primitive attributes; and modeling per-identity variations as offsets from the canonical template.

In Example 16, the subject matter of Examples 11-15 includes, wherein when fine-tuning the decoder network, the operations further comprise minimizing image reconstruction loss between an output rendered with the trained prior model and an input image by: computing color and opacity for pixel values associated with the rendered output and the input image by: projecting rendered output primitives and input image primitives at an angle; applying attributes of the rendered output primitives to the projected rendered output primitives, the rendered output primitives attributes being one of the scale, the rotation, the color, and the opacity; applying attributes of the input image primitives to the projected input image primitives, the input image primitive attributes being one of the scale, the rotation, the color, and the opacity; and blending projected rendered output primitives with the projected input image primitives.

In Example 17, the subject matter of Examples 11-16 includes, wherein when refining the adjusted initial set of primitive attributes the operations further comprise computing pixel values by projecting the plurality of three-dimensional primitives includes: computing color and opacity for pixel values associated with the projected plurality of three-dimensional primitives by: projecting the plurality of three-dimensional primitives and input image primitives of the input image data at an angle; applying attributes to the plurality of three-dimensional primitives projected at the angle, the attributes applied to the plurality of three-dimensional primitives projected at the angle being one of the scale, the rotation, the color, and the opacity; applying attributes of the input image primitives to the projected input image primitives, the input image primitive attributes being one of the scale, the rotation, the color, and the opacity; and blending the plurality of three-dimensional primitives projected at the angle with the projected input image primitives.

In Example 18, the subject matter of Examples 11-17 includes, wherein when generating the initial set of primitive attributes the operations further comprise: concatenating a per-primitive feature vector of each of the initial set of primitive attributes with the identity vector; processing the concatenated per-primitive feature vectors through linear layers having a fixed number of dimensional outputs; and generating separate attribute outputs.

Example 19 is a device for generating a three-dimensional avatar of a person, the device comprising: means for receiving image data of the person depicting a view of a face of the person; means for processing the image data, using a prior model trained from a dataset of three-dimensional head models with varying physical features, to generate an identity vector that represents physical features of the person in the image data by meeting a similarity condition within a learned feature space of the prior model, wherein the prior model includes, a canonical template defining base primitive attributes and per-primitive feature vectors, the base primitive attributes of a 3D representation of a reference person, and the per-primitive feature vectors encoding semantic characteristics of a corresponding primitive, the prior model mapping primitives with similar feature vectors to similar base primitive attributes; means for generating, using a decoder network, an initial set of primitive attributes for a plurality of three-dimensional primitives representing the person in the image by processing the generated identity vector and the per-primitive feature vectors, wherein for each of the plurality of three-dimensional primitives, the primitive attributes comprise one or more of: position, scale, rotation, color or opacity parameters; means for adjusting weights of the decoder network while maintaining the identity vector and per-primitive feature vectors fixed; means for adjusting the initial set of primitive attributes to reduce deviation from the image data; means for refining the adjusted initial set of primitive attributes by: computing pixel values by projecting and compositing the plurality of three-dimensional primitives; and optimizing individual position, scale, rotation, color and opacity parameters to minimize deviation between the computed pixel values and the image data of the person, while applying distance constraints to limit deviation from the base primitive attributes generated by the decoder network; means for rendering the three-dimensional avatar by projecting the adjusted initial set of primitive attributes to generate a two-dimensional image, wherein the projecting comprises: receiving a target viewing angle; and for each primitive: projecting a position parameter of each primitive of the adjusted initial set of primitive attributes to the target viewing angle to generate a projected primitive; applying the adjusted initial set of primitive attributes of the primitive; and compositing the projected primitive with other projected primitives to generate pixels of the two-dimensional image.

In Example 20, the subject matter of Examples 11-19 includes, wherein the device further comprises means training the prior model that comprises: generating synthetic training data including multiple three-dimensional head models with varying physical features where generating the synthetic training data includes: randomly generating a plurality of identities with different features; illuminating each identity of the plurality of identities with uniform white lighting; rendering multiple views of each head model to create training images; and optimizing the prior model to predict primitive attributes that reconstruct the training images.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

What is claimed is:

1. A method for generating a three-dimensional avatar of a person, comprising:
receiving image data of the person depicting a view of a face of the person;
processing the image data, using a prior model trained from a dataset of three-dimensional head models with varying physical features, to generate an identity vector that represents physical features of the person in the image data by meeting a similarity condition within a learned feature space of the prior model, wherein the prior model includes a canonical template defining base primitive attributes and per-primitive feature vectors, the base primitive attributes of a 3D representation of a reference person, and the per-primitive feature vectors encoding semantic characteristics of a corresponding primitive, the prior model mapping primitives with similar feature vectors to similar base primitive attributes;
generating, using a decoder network, an initial set of primitive attributes for a plurality of three-dimensional primitives representing the person in the image by processing the generated identity vector and the per-primitive feature vectors, wherein for each of the plurality of three-dimensional primitives, the primitive attributes comprise one or more of: position, scale, rotation, color or opacity parameters;
adjusting weights of the decoder network while maintaining the identity vector and per-primitive feature vectors fixed;
adjusting the initial set of primitive attributes to reduce deviation from the image data;
refining the adjusted initial set of primitive attributes by:
computing pixel values by projecting and compositing the plurality of three-dimensional primitives; and
optimizing individual position, scale, rotation, color and opacity parameters to minimize deviation between the computed pixel values and the image data of the person, while applying distance constraints to limit deviation from the base primitive attributes generated by the decoder network;
rendering the three-dimensional avatar by projecting the adjusted initial set of primitive attributes to generate a two-dimensional image, wherein the projecting comprises:
receiving a target viewing angle; and
for each primitive:
projecting a position parameter of each primitive of the adjusted initial set of primitive attributes to the target viewing angle to generate a projected primitive;
applying the adjusted initial set of primitive attributes of the primitive; and
compositing the projected primitive with other projected primitives to generate pixels of the two-dimensional image.

2. The method of claim 1, wherein the method further comprises training the prior model that comprises:
generating synthetic training data including multiple three-dimensional head models with varying physical features where generating the synthetic training data includes:
randomly generating a plurality of identities with different features;
illuminating each identity of the plurality of identities with uniform white lighting;
rendering multiple views of each head model to create training images; and
optimizing the prior model to predict primitive attributes that reconstruct the training images.

3. The method of claim 1, wherein the method further comprises training the prior model that comprises:
optimizing a loss function that includes pixel-level loss, perceptual loss, alpha mask loss, and regularization loss components, where optimizing the regularization loss components comprises:
applying scale regularization to primitive scale parameters; and
applying displacement regularization to primitive position parameters.

4. The method of claim 1, wherein the method further comprises training the prior model that comprises learning semantic correlations between per-primitive feature vectors where primitives with similar semantic features are mapped to similar attributes.

5. The method of claim 1, wherein the method further comprises training the prior model that comprises:
learning a canonical Gaussian template representing mean avatar primitive attributes; and
modeling per-identity variations as offsets from the canonical template.

6. The method of claim 1, wherein fine-tuning the decoder network comprises minimizing image reconstruction loss between an output rendered with the trained prior model and an input image by:
computing color and opacity for pixel values associated with the rendered output and the input image by:
projecting rendered output primitives and input image primitives at an angle;
applying attributes of the rendered output primitives to the projected rendered output primitives, the rendered output primitives attributes being one of the scale, the rotation, the color, and the opacity;
applying attributes of the input image primitives to the projected input image primitives, the input image primitive attributes being one of the scale, the rotation, the color, and the opacity; and
blending projected rendered output primitives with the projected input image primitives.

7. The method of claim 1, wherein refining the adjusted initial set of primitive attributes by computing pixel values by projecting the plurality of three-dimensional primitives includes:
computing color and opacity for pixel values associated with the projected plurality of three-dimensional primitives by:
projecting the plurality of three-dimensional primitives and input image primitives of the input image data at an angle;
applying attributes to the plurality of three-dimensional primitives projected at the angle, the attributes applied to the plurality of three-dimensional primitives projected at the angle being one of the scale, the rotation, the color, and the opacity;
applying attributes of the input image primitives to the projected input image primitives, the input image primitive attributes being one of the scale, the rotation, the color, and the opacity; and
blending the plurality of three-dimensional primitives projected at the angle with the projected input image primitives.

8. The method of claim 1, wherein generating the initial set of primitive attributes comprises:
concatenating a per-primitive feature vector of each of the initial set of primitive attributes with the identity vector;
processing the concatenated per-primitive feature vectors through linear layers having a fixed number of dimensional outputs; and
generating separate attribute outputs.

9. The method of claim 8, wherein the fixed number of dimensional outputs is 256.

10. The method of claim 1, wherein the decoder network is trained by optimizing a loss function including pixel-level loss, perceptual loss, alpha mask loss, and regularization loss.

11. A computing device for generating a three-dimensional avatar of a person, the computing device comprising:
a processor;
a memory, storing instructions, which when executed by the processor cause the computing device to perform operations comprising:
receiving image data of the person depicting a view of a face of the person;
processing the image data, using a prior model trained from a dataset of three-dimensional head models with varying physical features, to generate an identity vector that represents physical features of the person in the image data by meeting a similarity condition within a learned feature space of the prior model, wherein the prior model includes a canonical template defining base primitive attributes and per-primitive feature vectors, the base primitive attributes of a 3D representation of a reference person, and the per-primitive feature vectors encoding semantic characteristics of a corresponding primitive, the prior model mapping primitives with similar feature vectors to similar base primitive attributes;
generating, using a decoder network, an initial set of primitive attributes for a plurality of three-dimensional primitives representing the person in the image by processing the generated identity vector and the per-primitive feature vectors, wherein for each of the plurality of three-dimensional primitives, the primitive attributes comprise one or more of: position, scale, rotation, color or opacity parameters;
adjusting weights of the decoder network while maintaining the identity vector and per-primitive feature vectors fixed;
adjusting the initial set of primitive attributes to reduce deviation from the image data;
refining the adjusted initial set of primitive attributes by:
computing pixel values by projecting and compositing the plurality of three-dimensional primitives; and
optimizing individual position, scale, rotation, color and opacity parameters to minimize deviation between the computed pixel values and the image data of the person, while applying distance constraints to limit deviation from the base primitive attributes generated by the decoder network;
rendering the three-dimensional avatar by projecting the adjusted initial set of primitive attributes to generate a two-dimensional image, wherein the projecting comprises:
receiving a target viewing angle; and
for each primitive:
projecting a position parameter of each primitive of the adjusted initial set of primitive attributes to the target viewing angle to generate a projected primitive;
applying the adjusted initial set of primitive attributes of the primitive; and
compositing the projected primitive with other projected primitives to generate pixels of the two-dimensional image.

12. The computing device of claim 11, wherein the operations further comprise training the prior model that comprises:
generating synthetic training data including multiple three-dimensional head models with varying physical features where generating the synthetic training data includes:
randomly generating a plurality of identities with different features;
illuminating each identity of the plurality of identities with uniform white lighting;
rendering multiple views of each head model to create training images; and
optimizing the prior model to predict primitive attributes that reconstruct the training images.

13. The computing device of claim 11, wherein the operations further comprise training the prior model that comprises:
optimizing a loss function that includes pixel-level loss, perceptual loss, alpha mask loss, and regularization loss components, where optimizing the regularization loss components comprises:
applying scale regularization to primitive scale parameters; and
applying displacement regularization to primitive position parameters.

14. The computing device of claim 11, wherein the operations further comprise training the prior model that comprises learning semantic correlations between per-primitive feature vectors where primitives with similar semantic features are mapped to similar attributes.

15. The computing device of claim 11, wherein the operations further comprise training the prior model that comprises:
learning a canonical Gaussian template representing mean avatar primitive attributes; and
modeling per-identity variations as offsets from the canonical template.

16. The computing device of claim 11, wherein when fine-tuning the decoder network, the operations further comprise minimizing image reconstruction loss between an output rendered with the trained prior model and an input image by:
computing color and opacity for pixel values associated with the rendered output and the input image by:
projecting rendered output primitives and input image primitives at an angle;
applying attributes of the rendered output primitives to the projected rendered output primitives, the rendered output primitives attributes being one of the scale, the rotation, the color, and the opacity;
applying attributes of the input image primitives to the projected input image primitives, the input image primitive attributes being one of the scale, the rotation, the color, and the opacity; and
blending projected rendered output primitives with the projected input image primitives.

17. The computing device of claim 11, wherein when refining the adjusted initial set of primitive attributes the operations further comprise computing pixel values by projecting the plurality of three-dimensional primitives includes:
computing color and opacity for pixel values associated with the projected plurality of three-dimensional primitives by:
projecting the plurality of three-dimensional primitives and input image primitives of the input image data at an angle;
applying attributes to the plurality of three-dimensional primitives projected at the angle, the attributes applied to the plurality of three-dimensional primitives projected at the angle being one of the scale, the rotation, the color, and the opacity;
applying attributes of the input image primitives to the projected input image primitives, the input image primitive attributes being one of the scale, the rotation, the color, and the opacity; and
blending the plurality of three-dimensional primitives projected at the angle with the projected input image primitives.

18. The computing device of claim 11, wherein when generating the initial set of primitive attributes the operations further comprise:
concatenating a per-primitive feature vector of each of the initial set of primitive attributes with the identity vector;
processing the concatenated per-primitive feature vectors through linear layers having a fixed number of dimensional outputs; and
generating separate attribute outputs.

19. A device for generating a three-dimensional avatar of a person, the device comprising:
means for receiving image data of the person depicting a view of a face of the person;
means for processing the image data, using a prior model trained from a dataset of three-dimensional head models with varying physical features, to generate an identity vector that represents physical features of the person in the image data by meeting a similarity condition within a learned feature space of the prior model, wherein the prior model includes a canonical template defining base primitive attributes and per-primitive feature vectors, the base primitive attributes of a 3D representation of a reference person, and the per-primitive feature vectors encoding semantic characteristics of a corresponding primitive, the prior model mapping primitives with similar feature vectors to similar base primitive attributes;
means for generating, using a decoder network, an initial set of primitive attributes for a plurality of three-dimensional primitives representing the person in the image by processing the generated identity vector and the per-primitive feature vectors, wherein for each of the plurality of three-dimensional primitives, the primitive attributes comprise one or more of: position, scale, rotation, color or opacity parameters;
means for adjusting weights of the decoder network while maintaining the identity vector and per-primitive feature vectors fixed;
means for adjusting the initial set of primitive attributes to reduce deviation from the image data;
means for refining the adjusted initial set of primitive attributes by:
computing pixel values by projecting and compositing the plurality of three-dimensional primitives; and
optimizing individual position, scale, rotation, color and opacity parameters to minimize deviation between the computed pixel values and the image data of the person, while applying distance constraints to limit deviation from the base primitive attributes generated by the decoder network;
means for rendering the three-dimensional avatar by projecting the adjusted initial set of primitive attributes to generate a two-dimensional image, wherein the projecting comprises:
receiving a target viewing angle; and
for each primitive:
projecting a position parameter of each primitive of the adjusted initial set of primitive attributes to the target viewing angle to generate a projected primitive;
applying the adjusted initial set of primitive attributes of the primitive; and
compositing the projected primitive with other projected primitives to generate pixels of the two-dimensional image.

20. The computing device of claim 11, wherein the device further comprises means training the prior model that comprises:
generating synthetic training data including multiple three-dimensional head models with varying physical features where generating the synthetic training data includes:
randomly generating a plurality of identities with different features;
illuminating each identity of the plurality of identities with uniform white lighting;
rendering multiple views of each head model to create training images; and
optimizing the prior model to predict primitive attributes that reconstruct the training images.
optimizing a loss function that includes pixel-level loss, perceptual loss, alpha mask loss, and regularization loss components, where optimizing the regularization loss components comprises:
applying scale regularization to primitive scale parameters; and
applying displacement regularization to primitive position parameters.
learning semantic correlations between per-primitive feature vectors where primitives with similar semantic features are mapped to similar attributes.
learning a canonical Gaussian template representing mean avatar primitive attributes; and
modeling per-identity variations as offsets from the canonical template.
